(19) United States
(12) Patent Application Publication
(10) Pub. No.: US 2026/0071809 A1
(43) Pub. Date: Mar. 12, 2026

(54) REFRIGERATOR AND METHOD FOR CONTROLLING THE SAME

(71) Applicant: SAMSUNG ELECTRONICS CO., LTD., Suwon-si (KR)

(72) Inventors: Chanyoung PARK, Suwon-si (KR); Hyunuk PARK, Suwon-si (KR); Duckjin SUNG, Suwon-si (KR); Taein EOM, Suwon-si (KR); Jaewan HONG, Suwon-si (KR)

(73) Assignee: SAMSUNG ELECTRONICS CO., LTD., Suwon-si (KR)

(21) Appl. No.: 19/330,366

(22) Filed: Sep. 16, 2025

Related U.S. Application Data
(63) Continuation of application No. PCT/KR2025/012547, filed on Aug. 19, 2025.

(30) Foreign Application Priority Data
Aug. 26, 2024 (KR) 10-2024-0114513
Jan. 14, 2025 (KR) 10-2025-0005567

(51) Int. Cl. F25D 23/02; E05F 15/616

(52) U.S. Cl. CPC F25D 23/028; E05F 15/616; E05Y 2201/426; E05Y 2400/322; E05Y 2900/31; F25D 2323/02; F25D 2700/02

(57) ABSTRACT

The disclosure relates to a refrigerator and a method for controlling the same. The refrigerator includes: a main body having a storage compartment; a door; a door moving device including a motor, a door pusher to open the door using power generated by the motor, and a door link to close the door using power generated by the motor; an angle sensor configured to detect angles of the door that indicate positions of the door and output angle information about the detected angles; and a controller configured to: recognize a state of the door based on the angle information, in response to the state of the door being recognized, recognize angle change information based on the angle information, generate a closing trigger signal based on the recognized angle change information, and control the door moving device based on the generated closing trigger signal to close the door.

### CROSS-REFERENCE TO RELATED APPLICATION

This application is a continuation application is a continuation application, under 35 U.S.C. § 111 (a), of international application No. PCT/KR2025/012547, filed Aug. 19, 2025, which claims priority under 35 U. S. C. § 119 to Korean Patent Application No. 10-2024-0114513, filed Aug. 26, 2024, and Korean Patent Application No. 10-2025-0005567, filed Jan. 14, 2025, the disclosures of which are incorporated herein by reference in their entireties.

### TECHNICAL FIELD

The disclosure relates to a refrigerator that may control movement of a door for opening and closing a storage compartment, and a method for controlling the same.

### BACKGROUND ART

In general, a refrigerator is an apparatus that stores food at a low temperature in a storage compartment shielded by a door.

The refrigerator stores food in the storage compartment in an optimal state by cooling the storage compartment using cold air generated through heat exchange with refrigerant circulating in a refrigeration cycle.

Recent refrigerators include various convenience devices to improve user convenience.

Examples of the convenience devices include a display device that shows images or a list of food stored inside, a door with a transparent window that allows the inside of the storage compartment to be seen without opening the door, and a door moving device that moves the door to automatically open or close the storage compartment based on a user input received by a user interface.

In existing refrigerators equipped with door moving devices, an input interface for receiving a user input for a command to close a storage compartment is provided on the front of the door, which causes user inconvenience because users have to move to the front of the refrigerator door to input a close door command.

### DISCLOSURE

An aspect of the disclosure provides a refrigerator and a method for controlling the same that may recognize information about a change in an angle of a door based on the angle of the door detected by an angle sensor, generate a closing trigger signal based on the recognized information about the change in the angle of the door, and control an operation of a door moving device based on the generated closing trigger signal.

Another aspect of the disclosure provides a refrigerator and a method for controlling the same that may generate a closing trigger signal based on an opening time of a door being greater than or equal to a preset time or an angle of the door being less than or equal to a preset angle, and control an operation of a door moving device based on the generated closing trigger signal.

According to an aspect of the disclosure, a refrigerator may include: a main body having a storage compartment; a door configured to move in a first direction to open the storage compartment and move in a second direction to close the storage compartment; a door moving device including a motor to generate power, a door pusher configured to apply a repulsive force to the door to open the door using the power generated by the motor, and a door link configured to apply an attractive force to the door to close the door using the power generated by the motor; an angle sensor configured to detect angles of the door that indicate positions of the door and output angle information about the detected angles; and a controller configured to: recognize a state of the door based on the angle information, in response to the state of the door being recognized as moving in the second direction, recognize angle change information of the door based on the angle information, generate a closing trigger signal based on the recognized angle change information of the door, and control the door moving device based on the generated closing trigger signal so that the door link applies the attractive force to the door to close the door using the power generated by the motor.

According to an aspect of the disclosure, the controller of the refrigerator may be configured to recognize an amount of change between the detected angles based on the recognized angle change information of the door, and generate the closing trigger signal based on the amount of change between the detected angles being greater than or equal to a reference amount of change.

According to an aspect of the disclosure, the controller of the refrigerator may be configured to recognize a speed of change between the detected angles based on the recognized angle change information of the door, and generate the closing trigger signal based on the speed of change between the detected angles being greater than or equal to a reference speed of change.

According to an aspect of the disclosure, the controller of the refrigerator may be configured to recognize a time of change between detection of the detected angles based on the recognized angle change information of the door, and generate the closing trigger signal based on the recognized time of change being greater than or equal to a reference time.

According to an aspect of the disclosure, the controller of the refrigerator may be configured to recognize an angle of the door from the detected angles of the door based on the recognized angle information, and generate the closing trigger signal based on the recognized angle of the door being less than or equal to a preset angle.

According to an aspect of the disclosure, the controller of the refrigerator may be configured to measure an opening time during which the door is open, and generate the closing trigger signal based on the measured opening time being greater than or equal to a preset time.

According to an aspect of the disclosure, the refrigerator may further include an opening and closing sensor configured to detect an open state and a closed state of the door. According to an aspect of the disclosure, the controller of the refrigerator may be configured to recognize the state of the door based on detection of the open state or the closed state by the opening and closing sensor.

According to an aspect of the disclosure, the refrigerator may further include an input interface configured to receive an open door command. According to an aspect of the disclosure the door moving device may further include a link gear connected to the door link. According to an aspect of the disclosure, the controller of the refrigerator may be configured to control the door moving device based on the open door command being received via the input interface so that the door pusher applies the repulsive force to the door to open the door using power generated by the motor, and control the door moving device to allow the link gear to move based on the closing trigger signal being generated.

According to an aspect of the disclosure, the door moving device of the refrigerator may include a first gear assembly connected to the motor and configured to transmit the power generated by the motor as a moving force to the door pusher so that the door pusher applies the repulsive force to the door to open the door, and a second gear assembly connected to the motor and configured to transmit the power generated by the motor as a moving force to the door link so that the door link applies the attractive force to the door to close the door.

According to an aspect of the disclosure, the first gear assembly of the refrigerator may include a clutch gear configured to connect the motor and the door pusher to transmit the power generated by the motor to the door pusher so that the door pusher applies the repulsive force to the door to open the door, and connect the motor and the door link to transmit the power generated by the motor to the door link so that the door link applies the attractive force to the door to close the door.

According to an aspect of the disclosure, the second gear assembly of the refrigerator may include a link gear connected to the door link. The link gear may be configured to be rotated by the door link as the door is opened, and to move the door link using the power generated by the motor so that the door link applies the attractive force to the door to close the door.

According to an aspect of the disclosure, the angle sensor of the refrigerator may include a magnet in the link gear configured to rotate in conjunction with the link gear, and a signal generator configured to generate a signal corresponding to a magnetic field of the magnet and transmit the generated signal to the controller.

According to another aspect of the disclosure, a method for controlling a refrigerator that includes a main body having a storage compartment, a door configured to move in a first direction to open the storage compartment and move in a second direction to close the storage compartment, a door moving device that includes a motor to generate power, a door pusher configured to apply a repulsive force to the door to open the door using the power generated by the motor, and a door link configured to apply an attractive force to the door to close the door using the power generated by the motor, and an angle sensor configured to detect angles of the door that indicate positions of the door and output angle information about the detected angles may include: recognizing a state of a door based on the angle information; in response to the state of the door being recognized as moving in the second direction, recognizing angle change information of the door based on the angle information; generating a closing trigger signal based on the recognized angle change information of the door; and controlling the door moving device based on the generated closing trigger signal so that the door link applies the attractive force to the door to close the door using the power generated by the motor.

The generating of the closing trigger signal based on the recognized angle change information of the door may include recognizing an amount of change between detected angles based on the recognized angle change information of the door, and generating the closing trigger signal based on the amount of change between detected angles being greater than or equal to a reference amount of change.

The generating of the closing trigger signal based on the recognized angle change information of the door may include recognizing a speed of change between detected angles based on the recognized angle change information of the door, and generating the closing trigger signal based on the speed of change between detected angles being greater than or equal to a reference speed of change.

The generating of the closing trigger signal based on the recognized angle change information of the door may include recognizing a time of change between detection of the detected angles of the door changes based on the recognized angle change information of the door, and generating the closing trigger signal based on the recognized time of change being greater than or equal to a reference time.

According to an aspect of the disclosure, the method may further include recognizing an angle of the door from the detected angles of the door based on the recognized angle information, and generating the closing trigger signal based on the recognized angle of the door being less than or equal to a preset angle.

According to an aspect of the disclosure, the method may further include measuring an opening time during which the door is open, and generating the closing trigger signal based on the measured opening time being greater than or equal to a preset time.

According to an aspect of the disclosure, the method may further include controlling the door moving device so that the door pusher applies a repulsive force to the door to open the door using power generated by the motor, based on an open door command being received via an input interface.

The controlling of the door moving device may include controlling the motor to rotate in a first rotation direction based on the open door command being received, and controlling the motor to rotate in a second rotation direction based on the generated closing trigger signal.

According to the disclosure, a user's intention to close a refrigerator door may be recognized based on a change in angle of the door, and thus the inconvenience of having to move the user's body part or whole body toward a user interface provided on a front of the door to close the door may be avoided.

According to the disclosure, a user's intention to close a refrigerator door may be recognized based on an angle change of the door caused by manual force, and the door may then be automatically closed based on the recognition of the intention, thereby closing the door with little effort and improving user convenience.

According to the disclosure, a refrigerator door may be automatically closed based on an angle or an opening time of the door, thereby preventing cold air leakage and power waste.

According to the disclosure, safety of a refrigerator may be improved, and thus the quality, marketability, and competitiveness of the refrigerator may be improved.

### DESCRIPTION OF DRAWINGS

FIG. 1 is a front view illustrating a state in which a door of a refrigerator is closed according to an embodiment of the disclosure.

FIG. 2 is a perspective view illustrating a state in which a door of a refrigerator is opened according to an embodiment of the disclosure.

FIG. 3 is a view illustrating an example of an arrangement of door moving devices of a refrigerator according to an embodiment of the disclosure.

FIG. 4 is an internal perspective view of a door moving device provided in a left door of a refrigerator according to an embodiment of the disclosure.

FIG. 5A and FIG. 5B illustrate an example of a first gear assembly of a door moving device provided in a left door of a refrigerator according to an embodiment of the disclosure.

FIG. 6 illustrates an example of a clutch gear provided in a first gear assembly of a door moving device of a refrigerator according to an embodiment of the disclosure.

FIG. 7A and FIG. 7B illustrate an example of a second gear assembly of a door moving device of a refrigerator according to an embodiment of the disclosure.

FIG. 8 is an exploded perspective view of a link gear provided in a second gear assembly of a door moving device of a refrigerator according to an embodiment of the disclosure.

FIG. 9 is a bottom perspective view illustrating a positional relationship between a magnet and an angle sensor provided in the link gear shown in FIG. 8.

FIG. 10 is a plan view of a magnet provided in the second gear assembly shown in FIG. 8.

FIG. 11 is a control block diagram of a refrigerator according to an embodiment of the disclosure.

FIG. 12A, FIG. 12B, and FIG. 12C illustrate an example of an operation of a door moving device when a door of a refrigerator is opened according to an embodiment of the disclosure.

FIG. 13A, FIG. 13B, and FIG. 13C illustrate an example of an operation of a door pusher and a door link provided in a door moving device when a door of a refrigerator is opened according to an embodiment of the disclosure.

FIG. 14 and FIG. 15 illustrate examples of a signal of an angle sensor provided in a door moving device of a refrigerator according to an embodiment of the disclosure.

FIG. 16, FIG. 17, and FIG. 18 illustrate examples for recognizing an intention to close a door of a refrigerator according to an embodiment of the disclosure.

FIG. 19 is a flowchart of a method for controlling a refrigerator according to an embodiment of the disclosure.

FIG. 20 is a flowchart of a method for controlling a modified refrigerator according to an embodiment of the disclosure.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Reference numerals used for method steps are just used for convenience of description, but not to limit an order of the steps. Thus, unless the context clearly dictates otherwise, the written order may be practiced otherwise.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. And then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a foaming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 5 degrees Celsius. The “freezing” may be freezing food or keeping food frozen, and for example, the freezing compartment may be maintained within a range of −23 degrees Celsius to −17 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. In accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data recorded/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor. The output interface may include a display, a speaker, and the like. The output interface may output various notifications, messages, information, and the like generated by the processor.

Hereinafter, a refrigerator according to various embodiments of the disclosure will be described in detail with reference to the accompanying drawings.

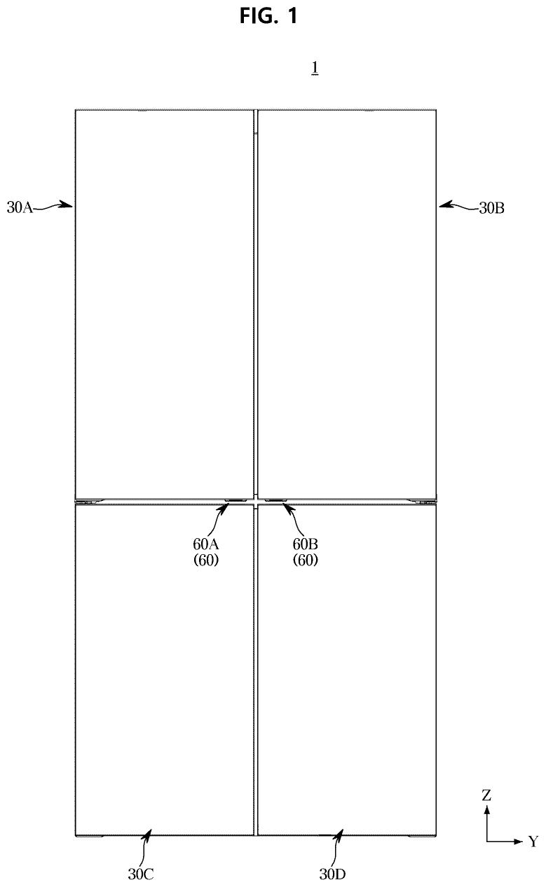

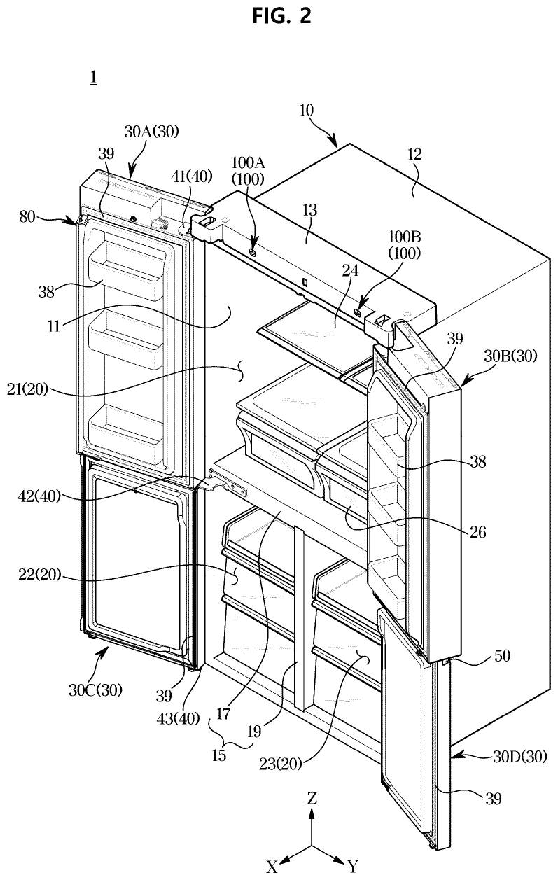

FIG. 1 is a front view illustrating a state in which a door of a refrigerator is closed according to an embodiment of the disclosure. FIG. 2 is a perspective view illustrating a state in which the door of the refrigerator is opened according to an embodiment of the disclosure.

As shown in FIG. 1, the refrigerator 1 according to an embodiment of the disclosure may include a plurality of doors 30A, 30B, 30C, and 30D, and a touch sensor 60 provided on some of the plurality of doors of the refrigerator to detect a user's touch input for automatic opening of the some doors.

Here, one or two or more touch sensors 60 may be provided. For example, the refrigerator 1 according to an embodiment of the disclosure may include a first touch sensor 60A disposed on the first door 30A among upper doors to detect a user's touch input for automatic opening of the first door 30A, and a second touch sensor 60B disposed on the second door 30B among the upper doors to detect a user's touch input for automatic opening of the second door 30B.

Although the embodiment describes an example of automatically opening the upper doors using the touch sensor, a device for receiving a command to open the upper doors is not limited to the touch sensor, and a microphone or a physical input device may also be used to receive a command to open the upper doors.

As shown in FIG. 2, the refrigerator 1 according to an embodiment of the disclosure may include a main body 10, a storage compartment 20 inside the main body 10, a door 30 for opening and closing the storage compartment 20, and a cooling system for supplying cold air to the storage compartment 20.

The main body 10 may include an inner case 11 forming the storage compartment 20 and an outer case 12 forming an exterior of the refrigerator 1.

The outer case 12 may be formed to have a shape of a box with a substantially open front. The outer case 12 may form an upper surface, a lower surface, left and right side surfaces, a rear surface, and the like of the refrigerator 1.

The inner case 11 may be open at the front. The inner case 11 may have the storage compartment 20 therein and may be provided inside the outer case 12. An inner wall of the inner case 11 may form an inner wall of the storage compartment 20.

A main body insulation may be provided between the outer case 12 and the inner case 11 of the main body 10 to insulate the outer case 12 and the inner case 11. The main body insulation may be foamed between the inner case 11 and the outer case 12 to couple the inner case 11 and the outer case 12 to each other. The main body insulation may prevent heat exchange from occurring between the inside of the storage compartment 20 and the outside of the main body 10, thereby improving the cooling efficiency inside the storage compartment 20. As the main body insulation of the main body 10, urethane foam insulation, expanded polystyrene (EPS) insulation, a vacuum insulation panel, or the like may be used. However, the disclosure is not limited thereto, and the main body insulation may be configured to include various materials.

The main body 10 may further include a top table 13 located on an upper portion of the main body 10. Specifically, the top table 13 may be coupled to the upper portion of the outer case 12. The top table 13 may be coupled to an upper side of the outer case 12.

The top table 13 may cover various electronic components. An accommodation space for accommodating various electronic components may be formed in the top table 13. For example, the top table 13 may cover a door moving device 100 to be described later. In this case, the door moving device 100 may be accommodated in the top table 13.

The storage compartment 20 may be provided inside the main body 10. For example, the storage compartment 20 may include a refrigerating compartment maintained at approximately 0 to 5 degrees Celsius to store food in a refrigerated state. For example, the storage compartment 20 may include a freezing compartment maintained at approximately minus 30 to 0 degrees Celsius to store food in a frozen state.

For example, the storage compartment 20 may be divided into a plurality of areas by a partition 15. Specifically, the storage compartment 20 may be divided into an upper first storage compartment 21 and lower storage compartments 22 and 23 by a first partition 17 extending in a horizontal direction.

In addition, the lower storage compartments 22 and 23 of the storage compartment 20 may be divided into the left second storage compartment 22 and the right third storage compartment 23 by a second partition 19 extending in a vertical direction. Here, for example, the first storage compartment 21 may be used as a refrigerating compartment, and the second storage compartment 22 and the third storage compartment 23 may both be used as freezing compartments. Alternatively, one of the second storage compartment 22 and the third storage compartment 23 may be used as a freezing compartment and the other may be used as a refrigerating compartment.

The division method of the storage compartment 20 described above and the use of each of the divided storage compartments 21, 22, and 23 are merely an example and are not limited thereto.

Inside the storage compartment 20, a shelf 24 on which food may be placed and a storage container 26 for storing food may be provided.

The refrigerator 1 may include a cooling system to generate cold air using a cooling cycle and supply the generated cold air to the storage compartment 20. The cooling system may generate cold air using a refrigeration circulation cycle that compresses, condenses, expands, and evaporates refrigerant. For example, the cooling system may include a compressor, a condenser, an expansion valve, an evaporator, a blowing fan, and the like. The cold air generated by the cooling system may be supplied to the storage compartment 20 through a cold air supply duct formed at a rear portion of the inner case 11.

The door 30 may open and close the storage compartment 20. The door 30 may open and close an opening formed on one side of the main body 10. The door 30 may be rotatable with respect to the main body 10.

An outer side of the door 30 may form a part of the exterior of the refrigerator 1. In a position where the door 30 is closed, the outer side of the door 30 may form at least a part of the front exterior of the refrigerator 1. In a state where the door 30 is closed, an inner side of the door 30 may face the inside of the storage compartment 20. The inner side of the door 30 refers to one surface of the door 30 that faces the storage compartment 20 while the door 30 is closing the storage compartment 20. In addition, the outer side of the door 30 refers to the other surface opposite to the inner side of the door 30 that faces the storage compartment 20 while the door 30 is closing the storage compartment 20, and refers to the front surface of the door 30 that is visible when the refrigerator 1 is viewed from the front.

A door basket 38 for storing food may be disposed on the inner side of the door 30. A door gasket 39 may be provided on the inner side of the door 30 to seal a gap between the door 30 and the main body 10 to prevent leakage of cold air from the storage compartment 20.

The refrigerator 1 may include an upper door and a lower door arranged parallel to each other in a vertical direction Z. The refrigerator 1 may include a left door and a right door arranged parallel to each other in a horizontal direction Y. The refrigerator 1 may include a plurality of doors 30A, 30B, 30C, and 30D for opening and closing each of the divided storage compartments 21, 22, and 23.

The first storage compartment 21 may be opened and closed by a pair of upper doors 30A and 30B. The refrigerator 1 may include the first door 30A that opens and closes a portion of the first storage compartment 21, and the second door 30B that opens and closes another portion of the first storage compartment 21. The first door 30A and the second door 30B may be rotatable independently of each other with respect to the main body 10. The first door 30A and the second door 30B may be arranged parallel to each other in the horizontal direction Y direction. For example, the first door 30A may open and close a left portion of the first storage compartment 21, and the second door 30B may open and close a right portion of the first storage compartment 22.

A rotating bar 80 may be provided on one of the pair of upper doors 30A and 30B (for example, the first door 30A). The rotating bar 80 may be rotatable with respect to the one door and may cover a gap between the pair of upper doors 30A and 30B when the pair of upper doors 30A and 30B closes the first storage compartment 21.

The second storage compartment 22 may be opened and closed by the left lower door 30C. The refrigerator 1 may include the third door 30C provided to open and close the second storage compartment 22. The third door 30C may be rotatable with respect to the main body 10. For example, the first door 30A and the third door 30C may be arranged parallel to each other in the vertical direction Z.

The third storage compartment 23 may be opened and closed by the right lower door 30D. The refrigerator 1 may include the fourth door 30D provided to open and close the third storage compartment 23. The fourth door 30D may be rotatable with respect to the main body 10. For example, the second door 30B and the fourth door 30D may be arranged parallel to each other in the vertical direction Z. In addition, the third door 30C and the fourth door 30D may be arranged parallel to each other in the horizontal direction Y.

A handle may be provided on each of the plurality of doors 30A, 30B, 30C, and 30D. A user may open or close each of the doors 30A, 30B, 30C, and 30D by holding the handle provided on each of the plurality of doors 30A, 30B, 30C, and 30D. In other words, a user may open or close each storage compartment 21, 22, and 23 by holding the handle provided on each. For example, the handle provided on each of the plurality of doors 30A, 30B, 30C, and 30D may have a groove concavely formed to be gripped.

The handles provided on the third door 30C and the fourth door 30D are described below as an example.

A portion of an upper end side of the third door 30C may include a handle area 50.

The portion of the upper end side of the third door 30C may be a right side of the upper end side of the third door 30C. The right side of the upper end side of the third door 30C may be a surface corresponding to a central area of the main body 10 of the refrigerator.

A front of the handle area 50 of the third door 30C may include a groove portion recessed downward by a predetermined length from the upper end side of the third door.

A user may insert their hand into the groove portion 50 of the third door 30C. The user may open the third door 30C by putting their hand into the groove portion and then pulling the third door. Here, the groove portion may be a handle area.

A portion of an upper end side of the fourth door 30D may include a handle area 50.

The portion of the upper end side of the fourth door 30D may be a left side of the upper end side of the fourth door 30D. The left side of the upper end side of the fourth door 30D may be a surface corresponding to the central area of the main body 10 of the refrigerator.

A front of the handle area 50 of the fourth door 30D may include a groove portion recessed downward by a predetermined length from the upper end side of the fourth door 30D.

A user may insert their hand into the groove portion 50 of the fourth door 30D. The user may open the fourth door 30D by putting their hand into the groove portion 50 and then pulling the fourth door 30D.

As will be described later, the upper door may be opened by the door moving device 100. For example, the first door 30A may be opened by a first door moving device 100A disposed on the left side. For example, the second door 30B may be opened by a second door moving device 100B disposed on the left side.

The refrigerator 1 may include a hinge 40 that connects the main body 10 and the door 30. The hinge 40 may allow the door 30 to be rotatable with respect to the main body 10. The hinge 40 may be fixed to the main body 10. Specifically, the hinge 40 may be coupled to the outer case 12.

The hinge 40 may rotatably support the door 30. The door 30 may be rotatably coupled to the main body 10 by the hinge 40.

Specifically, the refrigerator 1 may include a plurality of hinges 41, 42, and 43 to support the plurality of doors 30A, 30B, 30C, and 30D, respectively. For example, the refrigerator 1 may include a pair of upper door hinges 41 coupled to an upper portion of the main body 10 to rotatably support the first door 30A and the second door 30B, respectively. In addition, for example, the refrigerator 1 may include a pair of lower door hinges 43 coupled to a lower portion of the main body 10 to rotatably support the third door 30C and the fourth door 30D, respectively. In addition, for example, the refrigerator 1 may include a pair of middle hinges 42 disposed between the upper door hinge 41 and the lower door hinge 43, and coupled to a middle portion of the main body 10 (specifically, to the first partition 17) to rotatably support each of the first door 30A, the second door 30B, the third door 30B, and the fourth door 30D.

The configuration of the refrigerator 1 described above with reference to FIG. 1 and FIG. 2 is merely an example of the refrigerator according to an aspect of the disclosure, and the disclosure is not limited thereto.

In addition, although the refrigerator 1 according to an embodiment has been described as an example of the disclosure on the premise that the refrigerator 1 is an indirect cooling refrigerator, the disclosure is not limited thereto, and may be applied to a direct cooling refrigerator.

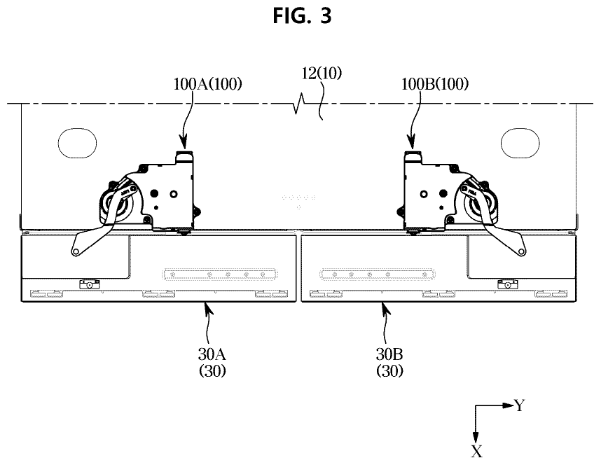

Hereinafter, a door moving device provided in the refrigerator according to an embodiment of the disclosure is described in detail with reference to FIG. 3 to FIG. 10.

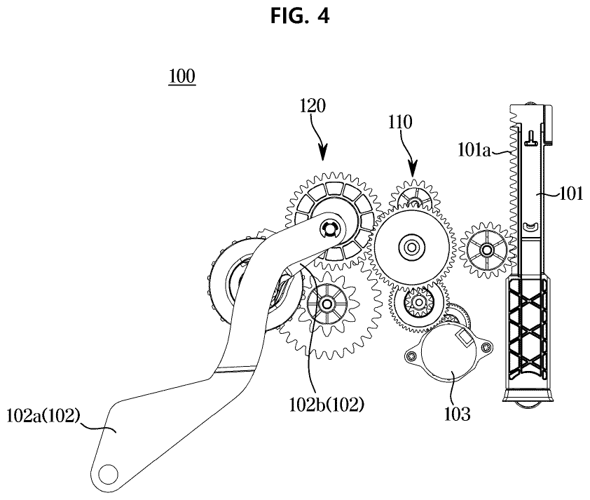

FIG. 3 is a view illustrating an example of an arrangement of door moving devices of a refrigerator according to an embodiment of the disclosure, and FIG. 4 is an internal perspective view of a door moving device provided in a left door of a refrigerator according to an embodiment of the disclosure.

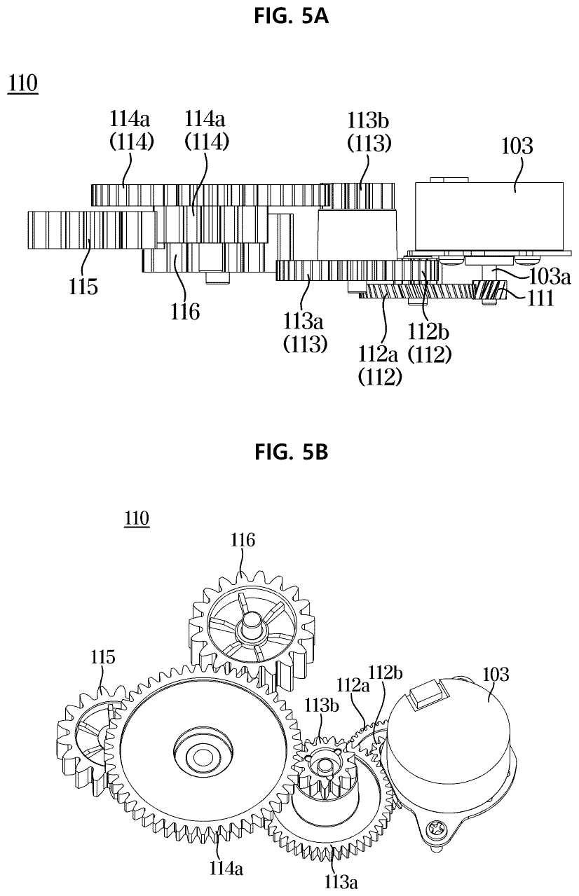

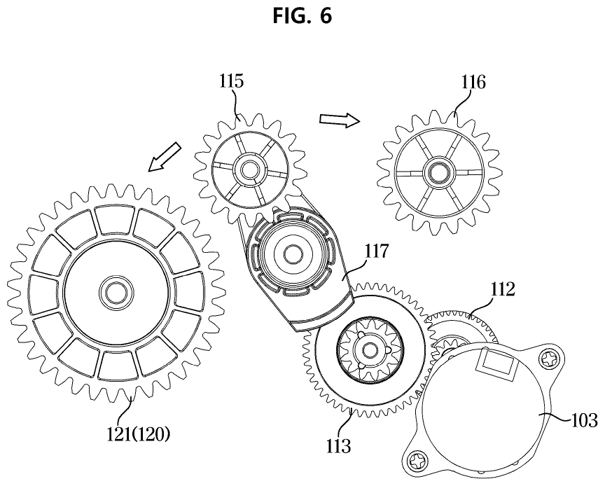

FIG. 5A and FIG. 5B illustrate an example of a first gear assembly of a door moving device provided in a left door of a refrigerator according to an embodiment of the disclosure, and FIG. 6 illustrates an example of a clutch gear provided in a first gear assembly of a door moving device of a refrigerator according to an embodiment of the disclosure.

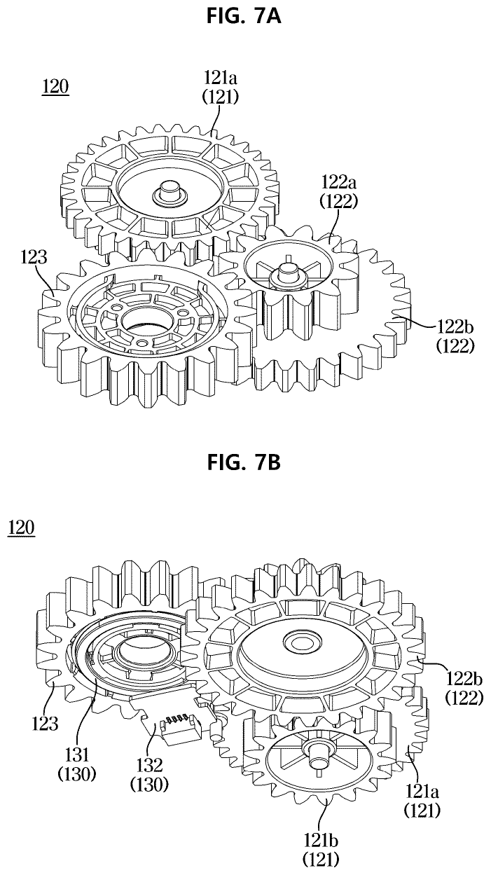

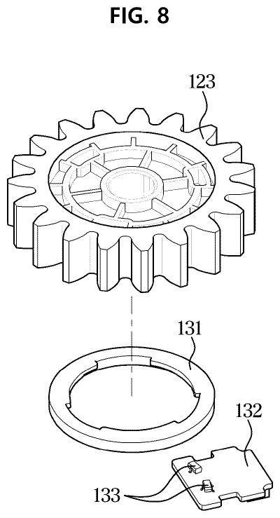

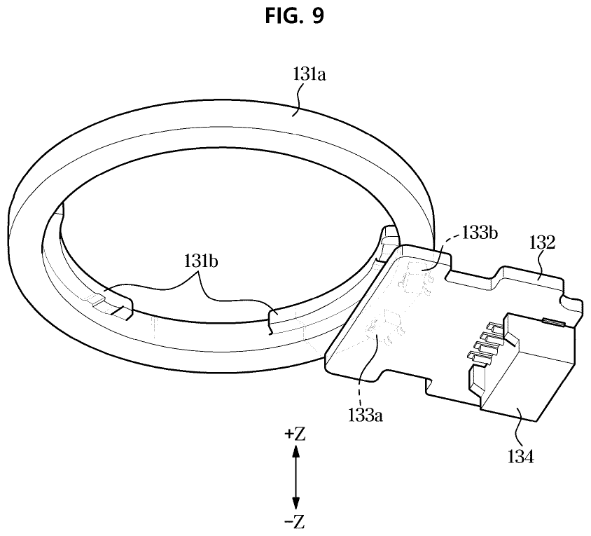

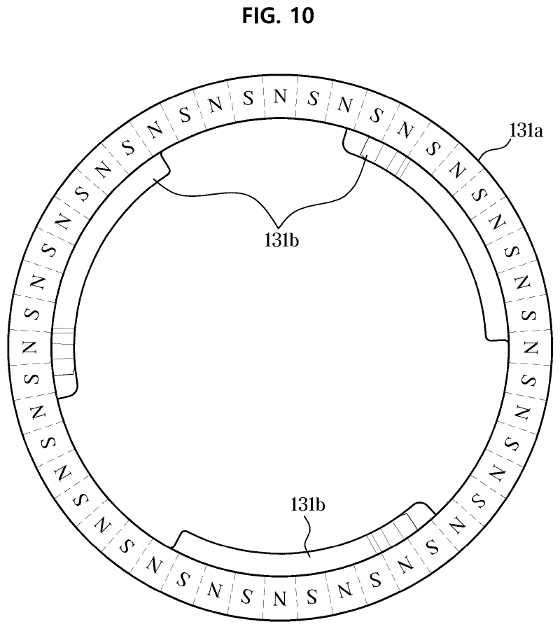

FIG. 7A and FIG. 7B illustrate an example of a second gear assembly of a door moving device of a refrigerator according to an embodiment of the disclosure, FIG. 8 is an exploded perspective view of a link gear provided in a second gear assembly of a door moving device of a refrigerator according to an embodiment of the disclosure, FIG. 9 is a bottom perspective view illustrating a positional relationship between a magnet and an angle sensor provided in the link gear shown in FIG. 8, and FIG. 10 is a plan view of a magnet provided in the second gear assembly shown in FIG. 8.

As shown in FIG. 3, the refrigerator 1 may include the door moving device 100 provided on the main body 10, specifically on an upper portion of the main body 10.

The door moving device 100 may be provided to move at least one of a plurality of doors of the main body 10. For example, the door moving device 100 may be connected to each of the plurality of doors of the main body to move each of the plurality of doors, or may be connected to two doors of the upper portion of the main body to move the two doors. That is, one or two or more door moving devices 100 may be provided.

The embodiment describes a refrigerator equipped with first and second door moving devices that move the two doors 30A and 30B on the upper portion of the main body, respectively, as an example.

The first door moving device 100A and the second door moving device 100B may be accommodated inside the top table 13. The upper sides of the first door moving device 100A and the second door moving device 100B may be covered by the top table 13. The door moving device 100 may be disposed on an upper surface of the outer case 12.

The first door moving device 100A and the second door moving device 100B may be arranged parallel to each other in the horizontal direction Y.

The first door moving device 100A may be disposed on the left side with respect to the center at the upper portion of the main body 10 and may move the first door 30A in a first direction and a second direction to automatically open and close the first storage compartment 21.

The second door moving device 100B may be disposed on the right side with respect to the center at the upper portion of the main body 10 and may move the second door 30B in the first direction and the second direction to automatically open and close the first storage compartment 21.

For example, the first direction may be a moving direction of the first and second doors to open the storage compartment, and the second direction may be a moving direction of the first and second doors to close the storage compartment. The first direction of the first door and the first direction of the second door may be different, and the second direction of the first door and the second direction of the second door may be different depending on a direction of an axis of the hinge to which each of the first and second doors is connected.

The first door moving device 100A and the second door moving device 100B may rotationally move (rotate) the first door 30A and the second door 30B, respectively, relative to the main body 10 about the hinge (as a rotational axis).

The first door moving device 100A may apply a repulsive force or an attractive force to the first door 30A, specifically to an upper portion of the first door 30A.

The second door moving device 100B may apply a repulsive force or an attractive force to the second door 30B, specifically to an upper portion of the second door 30B.

More specifically, the first door moving device 100A and the second door moving device 100B may apply a repulsive force to the first door 30A and the second door 30B, respectively, to cause the first door 30A and the second door 30B to rotationally move about the hinge 40, and may apply an attractive force (gravitation) to the first door 30A and the second door 30B, respectively, to cause the first door 30A and the second door 30B to rotationally move about the hinge 40.

The first door moving device 100A may move the first door 30A to cause a part of the first storage compartment 21 to be opened or closed. The second door moving device 100B may move the second door 30B to cause another part of the first storage compartment 21 to be opened or closed.

An operation of the first door moving device 100A moving the first door 30A and an operation of the second door moving device 100B moving the second door 30B may be performed independently of each other.

Hereinafter, a moving state in which the first door and the second door move to open the first storage compartment 21 is described as an open state of the first door and the second door, and a moving state in which the first door and the second door move to close the first storage compartment 21 is described as a closed state of the first door and the second door.

Hereinafter, a nonmoving state of the first door and the second door in which the first storage compartment 21 is open is described as an open state of the first door and the second door, and a nonmoving state of the first door and the second door in which the storage compartment is closed is described as a closed state of the first door and the second door.

An operation of the first door and the second door to open the first storage compartment 21 is described as opening of the first door and the second door, and an operation of the first door and the second door to close the first storage compartment 21 is described as closing of the first door and the second door.

Although the embodiment is an example in which the door moving device is located on the main body and applies a force to the door to open or close the door, the door moving device may be located on the first and second doors and applies a force to the main body to open or close the door.

The first door moving device 100A and the second door moving device 100B may have the same structure. The structure of the second door moving device 100B may also be applied to the first door moving device 100A.

Hereinafter, the structure of the first door moving device 100A and the second door moving device 100B are described together as the structure of the door moving device 100. A door moved by the door moving device 100 is described as the door 30.

As shown in FIG. 4, the door moving device 100 may include a door pusher 101, a door link 102, a motor 103, a first gear assembly 110, and a second gear assembly 120.

The door moving device 100 may include a case provided in the top table 13.

The case may accommodate the door pusher 101, the motor 103, the first gear assembly 110, and the second gear assembly 120. The door link 102 may be provided outside the case.

The door pusher 101 may apply a repulsive force to the door 30 to open the door 30.

The door pusher 101 may apply a repulsive force to the door 30 while moving relative to the main body 10. Specifically, the door pusher 101 may apply a force to the door 30 while moving forward from the main body 10 side toward the door 30, thereby transitioning the door 30 from a closed state to an open state.

The door pusher 101 may be capable of linear reciprocation with respect to the main body 10. The door pusher 101 may be linearly movable in a front-rear direction X with respect to the main body 10.

The door pusher 110 may apply a physical force to the door 30 while moving from a first position to a second position.

Here, the first position may be a position of the door pusher 101 when the door 30 is in a closed state. The first position may be a position when the door pusher 101 is located inside the main body. The second position may be a position of the door pusher 101 when the door is in an open state. The second position may be a position when the door pusher 101 is withdrawn outside the main body.

The door pusher 101 may move from the second position to the first position in a state where the door is completely opened. That is, the door pusher 101 may return to its original position.

The door pusher 101 may include a pusher rack 101a engaged with the first gear assembly 110.

The door pusher 101 may receive power from the first gear assembly 110 through the pusher rack 101a. For example, the first gear assembly 110 and the pusher rack 101a may form a rack-and-pinion gear structure.

The door link 102 may apply an attractive force to the door 30 while moving relative to the main body 10 to close the door 30. Specifically, the door link 102 may apply a force to the door 30 while moving toward the main body 10, thereby transitioning the door 30 from an open state to a closed state.

The door link 102 may be capable of reciprocation with respect to the main body 10.

The door link 102 may be provided outside the case and connected to the second gear assembly 120.

The door link 102 may include a first link 102a connected to the door 30, and a second link 102b connected to the first link 102a and the second gear assembly 120.

The second link 102b may be rotationally moved by the rotation of the second gear assembly.

The first link 102a of the door link 102 may be interlocked with the second link 102b. In this case, the first link 102a of the door link 102 may move in correspondence with the rotation of the second link 102b.

A length of the door link 102 may be decreased as the first link 102a and the second link 102b are bent in correspondence with the rotation of the second link 102b, or may be increased as the bent first link 102a and second link 102b are straightened.

The door link 102 may cause the door 30 to move toward the main body side by bending. The door link 102 may be straightened when the door is opened.

The motor 103 may generate power for the movement of the door pusher 101 and the door link 102.

The door moving device 100 may further include a motor driver connected to the motor 103. The motor 103 may receive a driving current from the motor driver to generate power. The motor driver may be electrically connected to a processor of the refrigerator 1 and may operate based on a control signal received from the controller.

The motor 103 may transmit power to the door pusher 101 using the first gear assembly 110, and may transmit power to the door link 102 using the second gear assembly 120.

The first gear assembly 110 may adjust the rotational force received from the motor 103 to a magnitude of force required for moving the door pusher 101. The force required for moving the door pusher 101 is a force that requires to be applied to the door 30 to open the door 30, and may be greater than or equal to a first reference magnitude.

The first gear assembly 110 may include one or two or more gears that may convert the rotational force of the motor 103 into a force of the first reference magnitude.

As shown in FIG. 5A and FIG. 5B, the first gear assembly 110 may include a first gear 111 connected to a shaft of the motor 103, a second gear 112 connected to the first gear 111, a third gear 113 connected to the second gear 112, a fourth gear 114 connected to the third gear 113, a fifth gear 115 connected to the fourth gear 114, and a sixth gear 116 connected to the fifth gear 115.

The first gear 111 may include a first helical gear, but the type of the first gear is not limited thereto.

The first gear 111 may be rotated by the rotational force received from the motor 10.

The second gear 112 may include a first double gear. The first double gear may include a second helical gear 112a and a first spur gear 112b.

The second helical gear 112a and the first spur gear 112b of the second gear may have different diameters.

The second helical gear 112a of the second gear may be engaged with the first gear 111, and may be rotated by the rotational force received from the first gear 111.

The first spur gear 112b of the second gear may rotate in conjunction with the second helical gear 112a of the second gear.

The first spur gear 112b of the second gear may be engaged with the third gear 113.

The third gear 113 may include a second double gear. The second double gear may include a second spur gear 113a and a third spur gear 113b. The second and third spur gears 113a and 113b may have different diameters.

The second spur gear 113a of the third gear 113 may be engaged with the first spur gear 112b of the second gear, and may be rotated by the rotational force received from the second gear 112.

The third spur gear 113b of the third gear 113 may be engaged with the fourth gear 114.

The third spur gear 113b of the third gear 113 may rotate in conjunction with the second spur gear 113a of the third gear 113.

The fourth gear 114 may include a third double gear. The third double gear may include a fourth spur gear 114a and a fifth spur gear 114b. The fourth and fifth spur gears 114a and 114b may have different diameters.

The fourth spur gear 114a of the fourth gear 114 may be engaged with the third spur gear 113b of the third gear, and may be rotated by the rotational force received from the third gear 113.

The fifth spur gear 114b of the fourth gear 114 may be engaged with the fifth gear 115. The fifth spur gear 114b of the fourth gear 114 may rotate in conjunction with the fourth spur gear 114a of the fourth gear 114.

The types of the second, third, and fourth gears 112, 113, and 114 are not limited to the above examples.

The fifth gear 115 may include a sixth spur gear, but the type of the fifth gear is not limited thereto.

The fifth gear 115 may include a clutch gear.

As shown in FIG. 6, the first gear assembly 110 may further include a moving plate 117 for moving the fifth gear 115.

The fifth gear 115 may be provided on the moving plate 117.

The moving plate 117 may move the fifth gear 115 based on a rotation direction and a rotation angle of the motor 103. That is, the fifth gear 115 may be moved toward the sixth gear 116 side or toward the second gear assembly side by the moving plate 117.

The fifth gear 115 may be connected to the sixth gear 116 when the door 30 is opened, and may be connected to the second gear assembly 120 when the door 30 is closed.

The fifth gear 115 may be connected to the sixth gear 116 even when the door 30 is completely opened.

The fifth gear 115 may transmit the rotational force received from the fourth gear 114 to the sixth gear 116, when connected to the sixth gear 116.

The fifth gear 115 may transmit the rotational force received from the fourth gear 114 to the second gear assembly 120, when connected to the second gear assembly 120.

The sixth gear 116 may include a seventh spur gear, but the type of the sixth gear 116 is not limited thereto.

The sixth gear 116 may be connected to the fifth gear 115 and to the pusher rack 101a of the door pusher. The sixth gear 116 and the rack of the door pusher may form a rack-and-pinion gear structure.

The sixth gear 116 may be rotated by the rotational force received from the fifth gear 116, and may transmit the rotational force to the pusher rack 101a of the door pusher.

The rotational force transmitted from the sixth gear 116 may be converted into a linear moving force at the pusher rack 101a of the door pusher.

The first, second, third, fourth, fifth, and sixth gears 111, 112, 113, 114, 115, and 116 may adjust the rotational force received from the motor 103 to a magnitude of force required for moving the door pusher 101.

The first gear assembly 110 may adjust the magnitude of the force transmitted to the door pusher 101 by the gear ratios of the first, second, third, fourth, fifth, and sixth gears.

The second gear assembly 120 may adjust the rotational force received from the motor 103 to a magnitude of force required for moving the door link 102. The force required for moving the door link 102 is a force that requires to be applied to the door 30 to close the door 30, and may be greater than or equal to a second reference magnitude.

The second gear assembly 120 may include one or two or more gears that may convert the rotational force of the motor 103 into a force of the second reference magnitude.

As shown in FIG. 7A and FIG. 7B, the second gear assembly 120 may include a seventh gear 121 connected to the fifth gear 115 of the first gear assembly 120, an eighth gear 122 connected to the seventh gear 121, and a ninth gear 123 connected to the eighth gear 122.

The seventh gear 121 may include a fourth double gear. The fourth double gear may include an eighth spur gear 121a and a ninth spur gear 121b. The diameters of the eighth and ninth spur gears 121a and 121b may be different.

The eighth spur gear 121a of the seventh gear 121 may be engaged with the fifth gear 115 of the first gear assembly 120, and may be rotated by the rotational force received from the fifth gear 115 of the first gear assembly 120.

The ninth spur gear 121b of the seventh gear 121 may rotate in conjunction with the eighth spur gear 121a of the seventh gear 121.

The ninth spur gear 121b of the seventh gear 121 may be connected to the eighth gear 122.

The eighth gear 122 may include a fifth double gear. The fifth double gear may include a tenth spur gear 122a and an eleventh spur gear 122b. The diameters of the tenth and eleventh spur gears 122a and 122b may be different.

The tenth spur gear 122a of the eighth gear 122 may be engaged with the ninth spur gear 121b of the seventh gear 121, and may be rotated by the rotational force received from the ninth spur gear 121b of the seventh gear 121.

The eleventh spur gear 122b of the eighth gear 122 may rotate in conjunction with the tenth spur gear 122a of the eighth gear 122.

The eleventh spur gear 122b of the eighth gear 122 may be connected to the ninth gear 123, and may transmit rotational force to the ninth gear 123.

The ninth gear 123 may include a twelfth spur gear. The ninth gear 123 may be a link gear.

The ninth gear 123 may be connected to the eleventh spur gear 122b of the eighth gear 122, and may receive rotational force from the eleventh spur gear 122b of the eighth gear 122.

The ninth gear 123 may be connected to the door link 102. A rotational shaft of the ninth gear 123 may be connected to the second link 102b of the door link 102.

The rotational force of the ninth gear 123 may be transmitted to the second link 102b of the door link 102. That is, the second link 102b of the door link 102 may rotate in conjunction with the rotation of the ninth gear 123.

A position of the first link 102a connected to the second link 102b may be changed by the rotation of the second link 102b of the door link 102, and thus a pose of the second link 102b and the first link 102a may be changed.

For example, the second link 102b and the first link 102a may be in a bent pose or an unbent pose in correspondence with a rotation angle of the second link 102b of the door link 102. As a result, an overall length of the door link 102 may increase or decrease.

When the door link 102 is in an unbent pose, the door may be in an open state. When the door link 102 is in a bent pose, the door may be in a closed state.

The seventh, eighth, and ninth gears 121, 122, and 123 may adjust the rotational force received from the motor 103 through the fifth gear 115 to a magnitude of force required for moving the door link 102.

The second gear assembly may adjust the magnitude of the force transmitted to the door link 102 by the gear ratios of the seventh, eighth, and ninth gears 121, 122, and 123.

The door moving device 100 may further include an angle sensor 130 for detecting an angles of the door. Here, the angles of the door may indicate positions of the door.

The angle sensor 130 may detect the angles of the door 30 in various ways. For example, the angle sensor 130 may be provided as an optical sensor, a hall sensor, or the like.

The embodiment describes a hall sensor detecting a magnetic field of a magnet 131 mounted on the ninth gear 123 as an example.

As shown in FIG. 8 and FIG. 9, the angle sensor 130 may include the magnet 131, a printed circuit board 132, and a signal generator 133.

The magnet 131 may be accommodated in the ninth gear 123. The magnet 131 may rotate in conjunction with the ninth gear 123.

The magnet 131 may interact with the signal generator 133 mounted on the printed circuit board 132 to allow a rotation angle of the ninth gear 123 to be detected. The rotation angle of the ninth gear 123 may correspond to the angle of the door.

The magnet 131 may have an annular shape.

As shown in FIG. 10, the magnet 131 may include a magnetic portion 131a and an inner protrusion 131b. The magnetic portion 131a may include a plurality of N poles and a plurality of S poles arranged alternately.

The inner protrusion 131b may be provided on an inner circumference of the magnet 131.

The printed circuit board 132 may be disposed adjacent to the magnet 131. For example, the printed circuit board 132 may be disposed below the magnet 131.

The signal generator 133 may be electrically connected to the printed circuit board 132. The signal generator 133 may be disposed adjacent to the magnet 131. For example, the signal generator 133 may be disposed below the magnet 131.

The signal generator 133 may generate a signal for detecting the angle of the ninth gear 123. For example, the signal generator 133 may detect a change in polarity of the magnet 131 and generate a signal corresponding to the detected change in polarity.

The signal generator 133 may detect the change of the N pole and S pole of the magnetic portion 131a, and may detect a rotation angle of the magnet 131 from the detected change. Here, the rotation angle of the magnet 131 may correspond to the rotation angle of the ninth gear 123 and may correspond to the angle of the door 30.

A plurality of signal generators 133 may be provided. For example, the signal generator 133 may include a first signal generator 133a and a second signal generator 133b.

For example, the first signal generator 133a may generate a first signal when a magnetic field from the S pole of the magnet 131 is detected, and may generate a second signal when a magnetic field from the N pole of the magnet 131 is detected. The first signal may be a 0 or low signal, and the second signal may be a 1 or high signal.

The second signal generator 133b may generate a first signal when a magnetic field from the S pole of the magnet 131 is detected, and may generate a second signal when a magnetic field from the N pole of the magnet 131 is detected. The first signal may be a 0 or low signal, and the second signal may be a 1 or high signal.

The angle sensor may further include a connector 134. The connector 134 may be coupled to the printed circuit board 132. The connector 134 may be electrically connected to the printed circuit board 132. For example, the connector 134 may be connected to a controller.

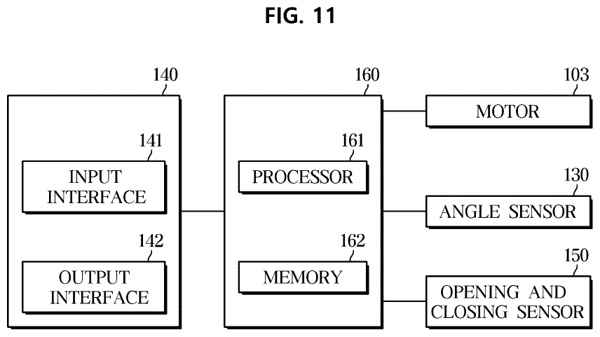

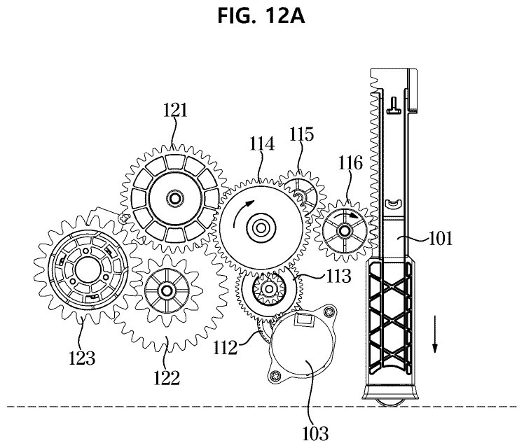

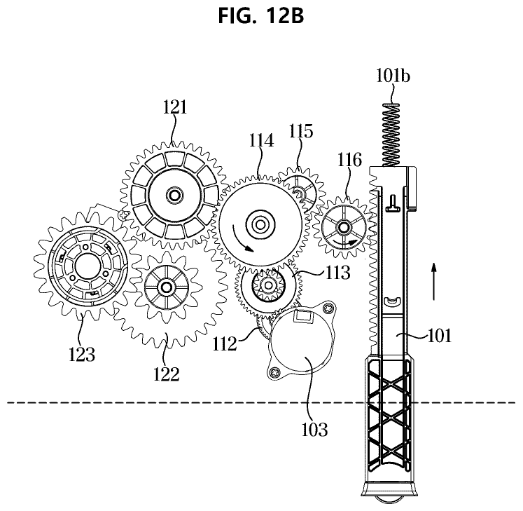

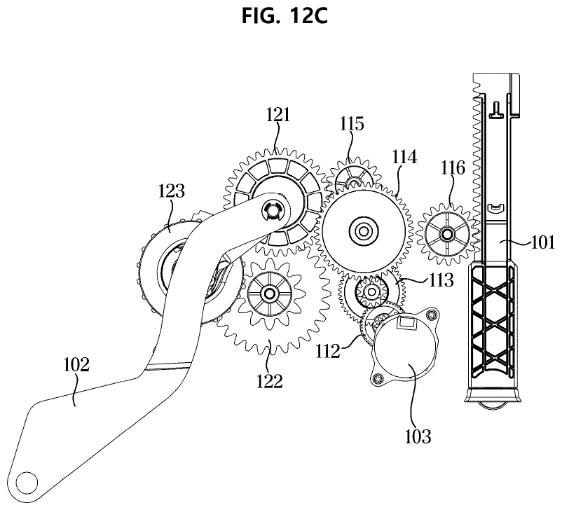

FIG. 11 is a control block diagram of a refrigerator according to an embodiment of the disclosure, which will be described with reference to FIGS. 12a, 12b, 12c, 13a, 13b, 13c, and 14 to 18.

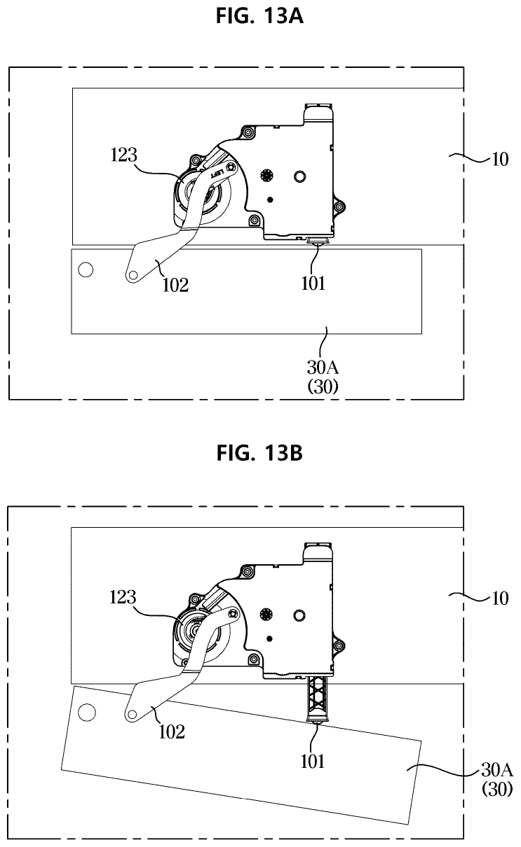

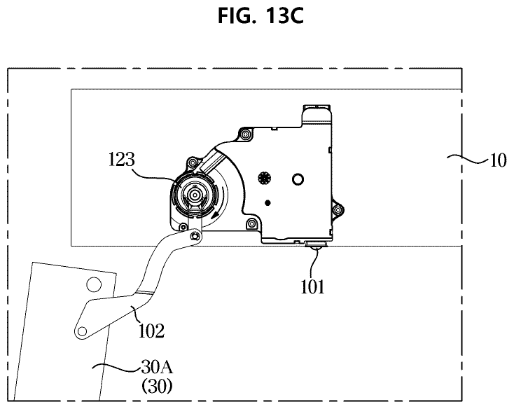

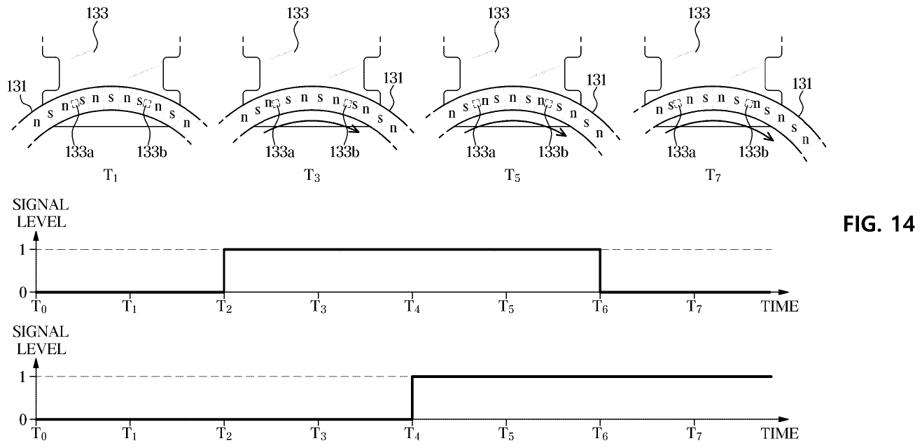

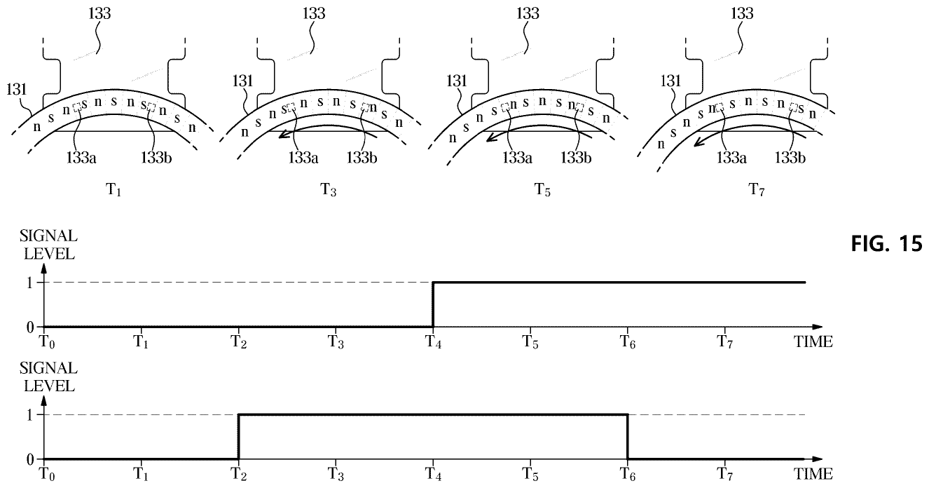

FIG. 12A, FIG. 12B, and FIG. 12C illustrate an example of an operation of a door moving device of a refrigerator according to an embodiment of the disclosure. FIG. 13A, FIG. 13B, and FIG. 13C illustrate an example of an operation of a door pusher and a door link provided in a door moving device of a refrigerator according to an embodiment of the disclosure. FIG. 14 and FIG. 15 illustrate examples of a signal of an angle sensor provided in a door moving device of a refrigerator according to an embodiment of the disclosure.

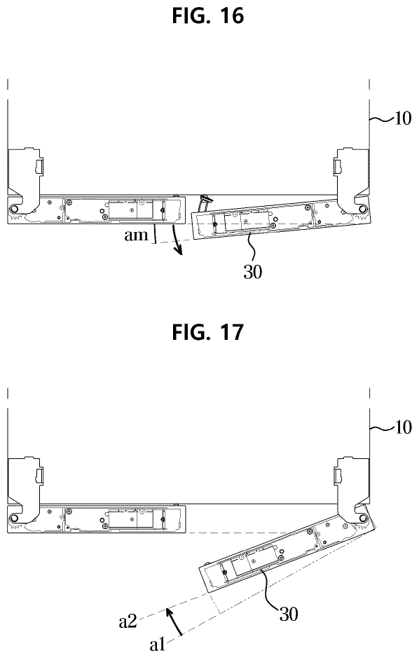

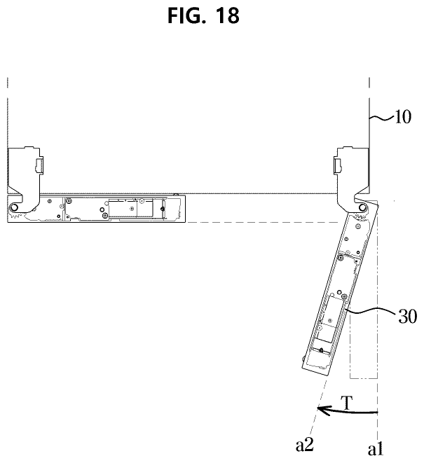

FIG. 16, FIG. 17, and FIG. 18 illustrate examples for recognizing an intention to close a door of a refrigerator according to an embodiment of the disclosure.

In the embodiment, the configurations for controlling the opening and closing of the plurality of doors may be the same. Accordingly, only the configuration for controlling the opening and closing of one door is described.

As shown in FIG. 11, the refrigerator 1 may include the motor 103, the angle sensor 130, a user interface 140, an opening and closing sensor 150, and a controller 160.

The motor 103 may be provided in the door moving device 100.

The motor 103 may rotate in response to a control command from the controller 160, and may generate power through rotation.

The motor 103 may transmit power to the first gear assembly 110 and the second gear assembly 120 of the door moving device 100.

The motor 103 may rotate in a first rotation direction or a second rotation direction, may rotate at a rotation speed corresponding to a control command from the controller 160, and may rotate at a rotation angle corresponding to a control command from the controller 160.

The first rotation direction may be opposite to the second rotation direction. For example, in a case where the first rotation direction is a clockwise direction, the second rotation direction may be a counterclockwise direction. In another example, in a case where the first rotation direction is a counterclockwise direction, the second rotation direction may be a clockwise direction.

The angle sensor 130 may detect an angle of the door 30 and transmit angle information about the detected angle of the door 30 to the controller 160. The angle of the door 30 may be the angle at which the door is opened. In this case, an angle of the door in a closed state may be 0 degrees.

The angle sensor 130 may be provided in the second gear assembly 120 of the door moving device 100, and may be electrically connected to the controller 160.

The angle sensor 130 may detect a rotation angle of the ninth gear 123 provided in the second gear assembly 120 of the door moving device.

The ninth gear 123 in which the magnet 131 is accommodated may be connected to the second link 102b of the door link 102 of the door moving device, may rotate in conjunction with the rotation of the second link 102b, and may cause the magnet 131 to rotate.

The second link 102b of the door link 102 may rotate in conjunction with the movement of the door 30.

The rotation angle of the ninth gear 123 may correspond to a rotation angle of the second link 102b of the door link 102, and may correspond to a rotation angle of the door 30.

When the door is opened, the ninth gear 123 may rotate in a first rotation direction by the second link 102b rotating in the first rotation direction.

When the door is closed, the ninth gear 123 may rotate in a second rotation direction and may transmit the rotational force for the rotation in the second rotation direction to the second link 102b.

The second link 102b of the door link may rotate in the second rotation direction in conjunction with the ninth gear 123. For example, the first rotation direction may be a clockwise direction. The second rotation direction may be a direction opposite to the first rotation direction, which may be a counterclockwise direction.

The angle sensor 130 may include a hall sensor detecting a magnetic field of the magnet 131, but the type of the angle sensor is not limited thereto.

In a case where a plurality of doors are provided in the refrigerator, the refrigerator may include a plurality of angle sensors for respectively detecting the angles of the plurality of doors.

The user interface 140 may be provided on one of the plurality of doors, specifically on a door panel 31.

The user interface 140 may receive a user input and output information related to the operation of the refrigerator.

The user interface 140 may include an input interface 141 for receiving a user input and an output interface 142 for outputting information related to the operation of the refrigerator.

The input interface 141 may receive a user input and transmit the user input to the controller 160.

The input interface 141 may receive a target temperature for each storage compartment, and may receive a storage mode for each storage compartment. Here, the storage mode may include a freezing mode, a refrigerating mode, a kimchi mode, a vegetable mode, and the like.

The input interface 141 may receive a command to open the door. In a case where a plurality of doors are provided in the refrigerator, the input interface 141 may receive identification information or an open door command for the door to be opened.

The refrigerator may further include a touch sensor provided on at least one of the plurality of doors to receive a command to open the at least one door.

The input interface 141 may include hardware devices such as a key, a button, a switch, a pedal, a mouse, a track-ball, a microphone, and the like.

The input interface 141 may also include a software device such as a touch pad, i.e., a graphical user interface (GUI). The touch pad may be implemented as a touch screen panel (TSP) and may form a mutual layer structure with a display.

The output interface 142 may output guidance information about automatic opening of at least one door, or guidance information about automatic closing of at least one door.

The output interface 142 may include a display and a speaker.

The display may display information related to a state or operation of the refrigerator 1 based on a control command from the controller 160, and may display information for guiding a user input.

The display may display information input to the input interface 141.

The display may display a target temperature for each storage compartment, and may display a storage mode for each storage compartment.

The display may display an open state and closed state of the plurality of doors.

The display may also display automatic opening information and automatic closing information of at least one door.

The display includes a plurality of seven-segments.

The display may be provided as a liquid crystal display (LCD), a digital light processing (DLP) panel, a plasma display panel, an electro luminescence (EL) panel, an electrophoretic display (EPD) panel, an electrochromic display (ECD) panel, a light emitting diode (LED) panel, or an organic light emitting diode (OLED) panel, but is not limited thereto.

The speaker may output information about a state or operation of the refrigerator 1 as a guidance sound based on a control command from the controller 160, and may output information for guiding a user input as a guidance sound.

The speaker may output a guidance sound corresponding to a change in the target temperature for each storage compartment, or a guidance sound corresponding to a change in the storage mode for each storage compartment.

The speaker may output a guidance sound for automatic opening of at least one door, or a guidance sound for automatic closing of at least one door.

The opening and closing sensor 150 may be provided in the main body 10, specifically in the storage compartment 20, may detect a state of the door 30, and may output detection information corresponding to the detected state of the door 30. Here, the state of the door 30 may include an open state and a closed state.

For example, the opening and closing sensor 150 may output a high signal based on the door 30 being in a closed state, and may output a low signal based on the door 30 being in an open state, without being limited thereto.

The opening and closing sensor 150 may include a micro switch, a limit switch, a magnetic switch, a reed switch, a toggle switch, a tact switch, and the like.

The opening and closing sensor 150 may include an optical sensor, an ultrasonic sensor, or an impact sensor, but is not limited thereto.

In a case where a plurality of doors are provided in the refrigerator, the refrigerator may include a plurality of opening and closing sensors for detecting a state of each of the plurality of doors.

The controller 160 may be electrically connected to various components of the refrigerator, and may control the various components. That is, the controller 160 may control the overall operation of the refrigerator 1.

The controller 160 may control the operation of the refrigerator 1 based on a user input received by the input interface 141.

The controller 160 may control the output interface 142 to output output information related to the operation of the refrigerator 1.

For example, the controller 160 may receive a target temperature for each storage compartment from the input interface 141, and may control the output interface 142 to display the received target temperature for each storage compartment.

The controller 160 may control an operation of the cooling system based on the target temperature for each storage compartment and a temperature detected by a temperature sensor (not shown) for each storage compartment.

Based on receiving a command to open the door 30 from the input interface 141, the controller 160 may control the door moving device 100.

In a case where a touch sensor is provided in the refrigerator, the controller 160 may control the door moving device 100 based on receiving a touch signal from the touch sensor. The touch signal may be a signal corresponding to a door command.

In recognizing a state of the door, the controller 160 recognizes whether the door 30 is in a closed state or an open state based on the detection information received from the opening and closing sensor 150.

In automatically controlling the closing of the door, the controller 160 may recognize whether the door is completely closed based on the detection information received from the opening and closing sensor 150.

In automatically controlling the closing of the door, the controller 160 may also recognize whether the door is completely closed based on the angle information received from the angle sensor 140.

The controller 160 may recognize the angle of the door based on the angle information received from the angle sensor 140.

The configuration of the controller 160 controlling the door moving device 100 to open the door is described below.

The controller 160 may control the motor 103 to rotate in the first rotation direction based on receiving a command to open the door (an open door command).

In controlling the motor 103 to rotate in the first rotation direction, the controller 160 may recognize an angle of the door 30 based on the angle information received from the angle sensor 130, and may control the motor 103 to stop rotating based on the recognized angle of the door 30 reaching a target angle.

In a case where a motor angle sensor (not shown) for detecting a rotation angle of the motor 103 is provided, in controlling the motor 103 to rotate in the first rotation direction, the controller 160 may control the motor 103 to stop rotating based on the rotation angle of the motor detected by the motor angle sensor reaching a target rotation angle.

In controlling the motor 103 to rotate in the first rotation direction, the controller 160 may also control the motor to rotate for a preset period of time. The preset period of time is a time during which the door is completely opened from a closed state, and may be information obtained through experiment.

Based on recognizing that the recognized angle of the door 30 has reached the target angle, the controller 160 may recognize that the door is completely opened.

Based on recognizing that the rotation angle of the motor has reached the target rotation angle, the controller 160 may also recognize that the door is completely opened.

Based on recognizing that a rotation time of the motor has reached a preset period of time, the controller 160 may also recognize that the door is completely opened.

Based on the rotation of the motor in the first rotation direction being stopped, the controller 160 may also recognize that the door is completely opened.

When the door is in a completely open state, the controller 160 may control the motor 103 to rotate in the second rotation direction.

In controlling the motor 103 to rotate in the second rotation direction, the controller 160 may recognize the angle of the door 30 based on the angle information received from the angle sensor 130, and may control the motor 103 to stop rotating based on the recognized angle of the door 30 reaching an initial angle. For example, the initial angle may be 0 degrees.

In a case where a motor angle sensor (not shown) for detecting a rotation angle of the motor 103 is provided, in controlling the motor 103 to rotate in the second rotation direction, the controller 160 may control the motor 103 to stop rotating based on the rotation angle of the motor detected by the motor angle sensor reaching a target rotation angle.

In controlling the motor 103 to rotate in the second rotation direction, the controller 160 may also control the motor 103 to rotate for a preset period of time.

An operation of the first assembly 110 of the door moving device 100 for automatic opening of the door 30 is described with reference to FIG. 12A, FIG. 12B, and FIG. 12C.

As shown in FIG. 12A, the fifth gear 115 of the first gear assembly may be engaged with the sixth gear 116 by the motor 103 rotating in the first rotation direction.

The power generated by the motor 103 may be transmitted to the sixth gear 116 through the first, second, third, fourth, and fifth gears 111, 112, 113, 114, and 115.

The sixth gear 116 may be rotated by the power transmitted through the fifth gear 115. The rotational force generated by the rotation of the sixth gear 116 may be transmitted to the pusher rack 101b of the door pusher. The rotational force of the sixth gear 116 may be converted into a linear moving force in a first moving direction at the pusher rack 101b of the door pusher.

The door pusher 101 may move from a first position to a second position by the generated linear moving force of the first moving direction. The door pusher 101 may protrude forward of the main body 10 by the movement of the door pusher 101 in the first moving direction, and may apply a repulsive force to the door 30.

The door 30 may be separated from the main body 10 by the applied repulsive force to allow the storage compartment to be opened.

As shown in FIG. 12B, once the door 30 is completely opened, the fifth gear 115 may be maintained in a state of being engaged with the sixth gear 116 by the elastic force of an elastic member 102b provided in the door pusher 101.

The power generated by the motor 103 rotating in the second rotation direction may be transmitted to the first, second, third, fourth, fifth gears 111, 112, 113, 114, and 115 and the sixth gear 116. However, as the motor 103 is changed to rotate in the second rotation direction, the rotation direction of the first, second, third, fourth, fifth gears 111, 112, 113, 114, and 115 and the sixth gear 116 may also be changed.

The rotational force generated by the rotation of the sixth gear 116 may be transmitted to the pusher rack 101b of the door pusher. The pusher rack 101b of the door pusher may convert the rotational force transmitted from the sixth gear 116 into a linear moving force. In this case, the pusher rack 101b of the door pusher may generate a linear moving force of a second moving direction by the change in the rotation direction of the sixth gear 116. The second moving direction may be opposite to the first moving direction.

The door pusher 101 may move from the second position to the first position by the moving force in the second moving direction. The door pusher 101 may be inserted into the main body 10 by the movement of the door pusher 101 in the second moving direction.

As shown in FIG. 12C, once the door pusher 101 is completely inserted, the elastic force of the elastic member 102b of the door pusher 101 is released, and the fifth gear 115 may be separated from the sixth gear 116.

An operation of the door link 102 of the door moving device during automatic opening of the door is described with reference to FIG. 13A, FIG. 13B, and FIG. 13C.

As shown in FIG. 13A, when the door is in a closed state, the first link 102a and the second link 102b of the door link may be in an overlapping pose. That is, the first link 102a and the second link 102b of the door link may be in a bent pose. As a result, a length of the door link may become a first length.

As shown in FIG. 13B, when the opening of the door is started, the door pusher 101 may be protruded from the main body 10, and the door 30 may move due to a repulsive force applied to the door 30 by the protruding door pusher 101.

A moving force of the door 30 moved by the door pusher is transmitted to the door link 102, and the ninth gear 123 of the second gear assembly is rotated in the first rotation direction by the moving force transmitted to the door link 102. That is, the second link 102b is also rotated in the first rotation direction by the moving force transmitted to the first link 102a of the door link.

As shown in FIG. 13C, when the door is completely opened, the door pusher 101 may be inserted into the main body 10.

When the door is in a completely open state, the first link 102a and the second link 102b of the door link may be in a stretched pose. That is, the first link 102a and the second link 102b of the door link may be in an unbent pose. As a result, the length of the door link may become a second length. The second length may be longer than the first length.

The door link 102 may have the second length by opening the door, or may have the first length by closing the door.

The controller 160 may recognize an angle of the door based on angle information received from the angle sensor 130 when the door is in an open state, which is described with reference to FIG. 14 and FIG. 15.

As shown in FIG. 14, in a case where the magnet 131 rotates in a clockwise direction due to the movement of the door 30, both the first signal generator 133a and the second signal generator 133b may generate a “0” signal at time Tl based on a magnetic field from the S pole of the magnet 131 being detected.

At time T3, the first signal generator 133a may generate a “1” signal based on a magnetic field from the N pole of the magnet 131 being detected, and the second signal generator 133b may generate a “O” signal based on a magnetic field from the S pole of the magnet 131 being detected.

At time T5, both the first signal generator 133a and the second signal generator 133b may generate a “1” signal based on a magnetic field from the N pole of the magnet 131 being detected.

At time T7, the first signal generator 133a may generate a “O” signal based on a magnetic field from the S pole of the magnet 131 being detected, and the second signal generator 133b may generate a “1” signal based on a magnetic field from the N pole of the magnet 131 being detected.

Accordingly, the signal generated by the first signal generator 133a may change from a “1” signal to a “O” signal due to the rotation of the magnet 131. For example, at approximately time T6, the first signal generator 133a may pass near the boundary between the N pole and the S pole of the magnet 131, and in this instance, may generate a “1” signal and then a “O” signal.

The signal generated by the second signal generator 133b may change from a “0” signal to a “1” signal due to the rotation of the magnet 131. For example, at approximately time T4, the second signal generator 133b may pass near the boundary between the N pole and the S pole of the magnet 131, and in this instance, may generate a “0” signal and then a “1” signal.

While the magnet 131 rotates in a clockwise direction, the first signal generator 133a and the second signal generator 133b may generate signals in the order of (0, 0), (1, 0), (1, 1), and (0, 1), and may transmit the generated signals to the controller 160.

The controller 160 may recognize the rotation of the magnet 131 based on a change in at least one of the signals received from the first signal generator 133a and the second signal generator 133b.

The controller 160 may recognize an angle (rotational displacement) that the magnet 131 has rotated based on a change in at least one of the signals received from the first signal generator 133a and the second signal generator 133b.

The controller 160 may recognize the angle that the magnet 131 has rotated based on the number of times the output signal of the first signal generator 133a or the signal received from the second signal generator 133b has changed.

As shown in FIG. 15, in a case where the magnet 131 rotates in a counterclockwise direction due to the rotation of the door 30, both the first signal generator 133a and the second signal generator 133b may generate a “0” signal at time Tl based on a magnetic field from the S pole of the magnet 131 being detected.

At time T3 when the magnet 131 has rotated in a counterclockwise direction, the first signal generator 133a may generate a “0” signal based on a magnetic field from the S pole of the magnet 131 being detected, and the second signal generator 133b may generate a “1” signal based on a magnetic field from the N pole of the magnet 131 being detected.

At time T5, both the first signal generator 133a and the second signal generator 133b may generate a “1” signal based on a magnetic field from the N pole of the magnet 131 being detected.

At time T7, the first signal generator 133a may generate a “1” signal based on a magnetic field from the N pole of the magnet 131 being detected, and the second signal generator 133b may generate a “0” signal based on a magnetic field from the S pole of the magnet 131 being detected.

While the magnet 131 rotates in a counterclockwise direction, the first signal generator 133a and the second signal generator 133b may generate signals in the order of (0, 0), (0, 1), (1, 1), and (1, 0), and may transmit the generated signals to the controller 160. As described above, while the magnet 131 rotates in a clockwise direction, the first signal generator 133a and the second signal generator 133b may generate signals in the order of (0, 0), (1, 0), (1, 1), and (0, 1).

As such, while the magnet 131 rotates in a clockwise direction, the output signal of the first signal generator 133a may change first, and then the output signal of the second signal generator 133b may change. Conversely, while the magnet 131 rotates in a counterclockwise direction, the output signal of the second signal generator 133b may change first, and then the output signal of the first signal generator 133a may change.

In other words, while the magnet 131 rotates in a clockwise direction, a phase of the output signal of the first signal generator 133a may lead a phase of the output signal of the second signal generator 133b. In addition, while the magnet 131 rotates in a counterclockwise direction, a phase of the output signal of the second signal generator 133b may lead a phase of the output signal of the first signal generator 133a.

The controller 160 may recognize whether the magnet 131 rotates in a clockwise direction or in a counterclockwise direction based on a change in the signal generated by the first signal generator 133a and a change in the signal generated by the second signal generator 133b.

The controller 160 may identify whether the door 30 is being opened or closed based on a comparison between the phase of the output signal of the first signal generator 133a and the phase of the output signal of the second signal generator 133b.

The controller 160 may identify the angle of the door 30 by accumulating the number of times at least one of the signal generated by the first signal generator 133a or the signal generated by the second signal generator 133b has changed while the door 30 is being opened.

The controller 160 may identify the angle of the door 30 by subtracting the number of times at least one of the signal generated by the first signal generator 133a or the signal generated by the second signal generator 133b has changed while the door 30 is being closed.

The controller 160 may recognize a user's intention to close the door based on the recognized angle of the door.

The configuration of the controller 160 recognizing the intention to close the door is described with reference to FIG. 16, FIG. 17, and FIG. 18.

As shown in FIG. 16, the controller 160 may recognize that a user intends to close the door based on a recognized angle (am) of the door being less than or equal to a preset angle. Here, the preset angle is a minimum angle of the door for putting food into or taking food out of the storage compartment, and may be obtained through experiment.

Based on recognizing that the door is in an open state, the controller 160 may measure an opening time of the door, and may recognize that the user intends to close the door based on the measured opening time of the door being greater than or equal to a preset opening time.

The controller 160 may recognize that the door is open based on detection information received from the opening and closing sensor 150, and may measure an opening time of the door from the time when the door is recognized as open.

The controller 160 may also recognize the angle of the door based on angle information received from the angle sensor 130, recognize that the door is open based on the recognized angle exceeding 0 degrees, and measure the opening time of the door from the time when the door is recognized as open.

The controller 160 may also measure the opening time of the door from the time when a command to open the door is received from the input interface 141 or the touch sensor 60.

The controller 160 may recognize whether the recognized angle of the door 30 changes.

Assuming that the angle of the door is 0 degrees when the door is in a closed state, the change in the angle of the door may include a decrease in the angle of the door.

In recognizing the change in the angle, the controller 160 may recognize whether the change in the angle is due to the closing of the door.

In recognizing the change in the angle, the controller 160 may recognize that the door is being closed when a rotation direction of the ninth gear is recognized as the second rotation direction. For example, the second rotation direction may be a counterclockwise direction.

In recognizing the change in the angle, the controller 160 may recognize the rotation direction of the ninth gear 123 of the second gear assembly based on the angle information received from the angle sensor 130, thereby recognizing whether the change in the angle due to the closing of the door 30.

Based on recognizing that the angle of the door 30 has changed, the controller 160 may recognize angle change information of the door 30 based on the angle information detected by the angle sensor 130.

The controller 160 may recognize the amount of change in the angle based on the angle change information of the door 30, and may recognize that the user intends to close the door based on the recognized amount of change in the angle.

As shown in FIG. 17, the controller 160 may recognize that the user intends to close the door based on the recognized amount of change in the angle (ac=a1−a2) being greater than or equal to a reference amount of change.

The controller 160 may recognize a speed of change in the angle based on the angle change information of the door, and may recognize that the user intends to close the door based on the recognized speed of change in the angle.

As shown in FIG. 18, the controller 160 may recognize the speed of change in the angle of the door based on the recognized amount of change in the angle (ac=a1−a2) and the time T during which the angle of the door changes from a first angle a1 to a second angle a2, and may recognize that the user intends to close the door based on the recognized speed of change in the angle being greater than or equal to a reference speed of change.

When the angle of the door continuously changes, the controller 160 may recognize a time of change during which the angle of the door changes, and may recognize that the user intends to close the door based on the recognized time of change. For example, the controller 160 may recognize that the user intends to close the door based on the recognized time of change being greater than or equal to a reference time.

Based on recognizing that there is no intention to close the door, the controller 160 may control to maintain the door in an open state. That is, the controller 160 may control the motor 103 to be maintained in a stopped state.

The controller 160 may generate a closing trigger signal based on recognizing that the user intends to close the door.

The controller 160 may control the output interface 142 to output guidance information for guiding that a door closing operation starts, based on the generated closing trigger signal.

Based on the generated closing trigger signal, the controller 160 may control the motor 103 to rotate in the second rotation direction, thereby allowing the door 30 to be automatically closed. This operation is described in more detail below.

Due to the rotation of the motor 103 in the second rotation direction, the fifth gear 115 may be engaged with the seventh gear 121 of the second gear assembly. The rotation of the motor 103 in the second rotation direction is maintained in a state where the fifth gear 115 is engaged with the seventh gear 121 of the second gear assembly, thereby rotating the seventh, eighth, and ninth gears 121, 122, and 123.

A moving force for the movement of the door link may be generated by the rotation of the seventh, eighth, and ninth gears 121, 122, and 123.

The second link 102b of the door link connected to the ninth gear 123 may rotate due to the rotational force of the ninth gear 123. When the rotational force of the second link 102b of the door link is transmitted to the first link 102a, the first link 102a may move along the second link 102b. In this way, when the first link 102a moves along the second link 102b, an attractive force is applied to the door 30, and the door 30 may move toward the main body 10 side. Also, as the door 30 moves toward the main body 10 side, the door 30 may be closed.

The controller 160 may recognize whether the door 30 is completely closed.

For example, the controller 160 may recognize an angle of the door 30 based on angle information detected by the angle sensor 130, and may recognize that the door 30 is completely closed based on the recognized angle being an initial angle.

In another example, the controller 160 may also recognize that the door 30 is completely closed based on recognizing that a rotation angle of the motor detected by a motor angle sensor (not shown) has reached a target rotation angle.

In still another example, the controller 160 may also recognize that the door 30 is completely closed based on detection information received from the opening and closing sensor 150.

The controller 160 may control the motor 103 to stop rotating based on recognizing that the door 30 is completely closed.

The controller 160 may control the output interface 142 to output guidance information for guiding automatic closing of the door based on recognizing that the user intends to close the door, and may control the output interface 142 to output guidance information for guiding the completion of automatic closing based on the closing of the door being completed.

The controller 160 may include at least one processor that controls the operation of the refrigerator 1 and at least one memory that stores programs and data for controlling the operation of the refrigerator 1.

The at least one processor may include one or more processor chips or one or more processing cores that perform the aforementioned operations using at least one memory that stores data in the form of algorithms and programs for controlling the operations of the internal components of the refrigerator 1, and the data stored in the at least one first memory.

The at least one processor may process various data and signals using instructions, data, programs, and/or software stored in the memory.

The at least one processor may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator.

The memory may store information about the rotation direction of the motor for opening the door and the rotation direction of the motor for closing the door.

The memory may store various information required to recognize the user's intention to close the door. For example, the memory may store information about a preset angle, a preset time, a reference amount of change, and a reference speed of change.

The memory may store data required for various embodiments.

The memory may be implemented as a memory embedded in the refrigerator 1 or as a memory detachable from the refrigerator 1, depending on a data storage use. For example, data for driving the refrigerator 1 may be stored in a memory embedded in the refrigerator 1, and data for an extended function of the refrigerator 1 may be stored in a memory detachable from the refrigerator 1.

Meanwhile, the memory embedded in the refrigerator 1 may be implemented as at least one of a volatile memory, such as, dynamic random access memory (DRAM), static RAM (SRAM), or synchronous dynamic RAM (SDRAM), etc., or a non-volatile memory, such as, one time programmable read only memory (OTPROM), programmable ROM (PROM), erasable and programmable ROM (EPROM), electrically erasable and programmable ROM (EEPROM), mask ROM, flash ROM, flash memory (e.g. NAND flash or NOR flash, etc.), a hard drive, or a solid state drive (SSD)).

In addition, the memory detachable from the refrigerator 1 may be implemented as a memory card (e.g., compact flash (CF), secure digital (SD), micro secure digital (Micro-SD), mini secure digital (Mini-SD), extreme digital (xD), multi-media card (MMC), etc.), an external memory (e.g., universal serial bus (USB) memory) connectable to a USB port, and the like, but is not limited thereto.

The memory may include one or more memory chips or one or more memory blocks.

At least one component may be added or omitted corresponding to the performance of the components of the refrigerator 1 shown in FIG. 11. In addition, it will be easily understood by those skilled in the art that the mutual positions of the components may be modified corresponding to the performance or structure of the refrigerator 1.

Each component shown in FIG. 11 refers to a software and/or hardware component such as a field programmable gate array (FPGA) and an application specific integrated circuit (ASIC).

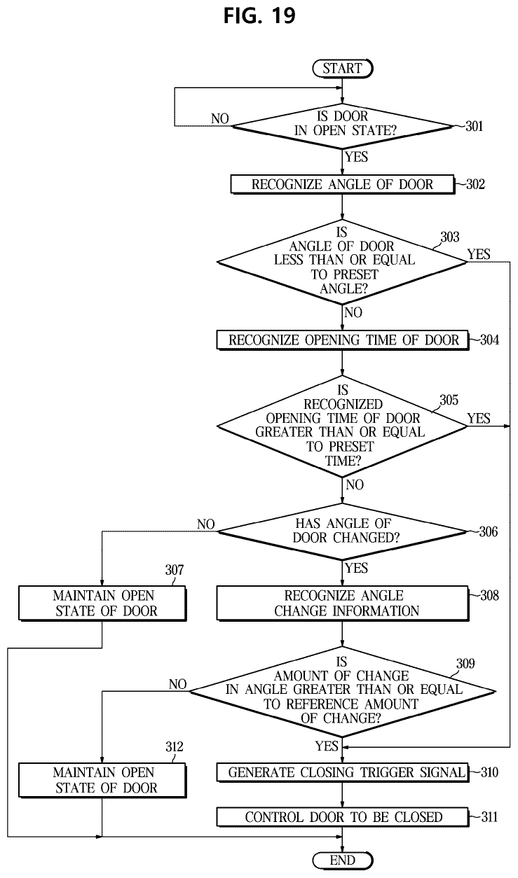

FIG. 19 is a flowchart of a method for controlling a refrigerator according to an embodiment of the disclosure.

The refrigerator may recognize whether the door is in an open state (301).

Recognizing whether the door is in an open state may include recognizing whether detection information received from the opening and closing sensor 150 is information corresponding to an open state, and recognizing that the door is open based on recognizing that the detection information received from the opening and closing sensor 150 is information corresponding to an open state. For example, recognizing whether the door is in an open state may include recognizing that the door is in an open state based on receiving a low signal from the opening and closing sensor 150.

Recognizing whether the door is in an open state may include recognizing an angle of the door based on angle information received from the angle sensor 130, and recognizing that the door is open based on the recognized angle of the door not being 0 degrees.

Based on recognizing that the door is in an open state, the refrigerator may measure an opening time of the door.

Based on recognizing that the door is in an open state, the refrigerator may recognize an angle of the opened door (302).

The refrigerator may recognize whether the recognized angle of the door is less than or equal to a preset angle (303).

The refrigerator may generate a closing trigger signal based on the recognized angle of the door being less than or equal to the preset angle (310).

The refrigerator may recognize a measured opening time of the door based on the recognized angle of the door exceeding the preset angle (304).

The refrigerator may recognize whether the measured opening time of the door is greater than or equal to a preset time (305).

The refrigerator may generate a closing trigger signal based on the measured opening time of the door being greater than or equal to the preset time (310). The preset time is a time for the cold air of the storage compartment to leak more than a reference amount, and may be a time obtained through experiment.

The refrigerator may maintain the open state of the door based on the recognized angle of the door exceeding the preset angle. In this case, the refrigerator may recognize the measured opening time of the door while maintaining the open state of the door.

The refrigerator may recognize whether the angle of the door has changed based on the measured opening time of the door being less than the preset time (306).

The refrigerator may maintain the open state of the door based on the angle of the door being maintained (307).

The refrigerator may maintain the open state of the door based on the measured opening time of the door being less than the preset time. In this case, the refrigerator may recognize whether the angle of the door has changed while maintaining the open state of the door.

The refrigerator may recognize angle change information of the door based on the angle information received from the angle sensor 130, based on recognizing a change in the angle of the door (308).

Recognizing the angle change information may include recognizing the amount of change in the angle.

Recognizing the amount of change in the angle may be a difference between an angle of the door in a state where the open state is maintained after the door is opened and a current angle of the door after the movement of the door has occurred.

The refrigerator may recognize whether the amount of change in the angle is greater than or equal to a reference amount of change (309).

The refrigerator may generate a closing trigger signal based on the amount of change in the angle being greater than or equal to the reference amount of change (310).

The refrigerator may control the door to be closed based on the closing trigger signal generated when the angle of the door is less than or equal to the preset angle, or the opening time of the door is greater than or equal to the preset time, or the amount of change in the angle of the door is greater than or equal to the reference amount of change (311).

The refrigerator may control the output interface to output a guidance sound for guiding automatic closing of the door based on the generated closing trigger signal.

Controlling the output interface may include controlling the speaker to output the guidance sound.

Controlling the door to be closed may include rotating the motor 103 in the second rotation direction. The second rotation direction may be opposite to the first rotation direction for opening the door.

The refrigerator may maintain the open state of the door based on the amount of change in the angle being less than the reference amount of change (312).

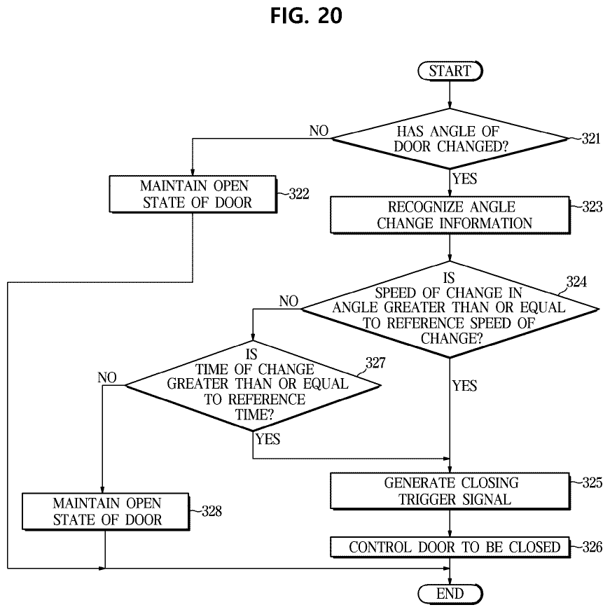

FIG. 20 is a flowchart of a method for controlling a modified refrigerator according to an embodiment of the disclosure.

When the door is in an open state, the refrigerator may recognize an angle of the opened door and recognize whether the angle of the door has changed based on the recognized angle of the door (321).

The refrigerator may maintain the open state of the door based on the angle of the door not being recognized as changed (322).

The refrigerator may recognize angle change information of the door based on angle information received from the angle sensor, based on recognizing a change in the angle of the door (323).

Recognizing the angle change information may include recognizing the amount of change in the angle. For example, recognizing the amount of change in the angle may be a difference between an angle of the door in a state where the open state is maintained after the door is opened and a current angle of the door after the movement of the door has occurred.

Recognizing the angle change information may include recognizing information about a time of change during which the angle changes.

Recognizing the angle change information may include recognizing a speed of change in the angle. For example, recognizing the speed of change in the angle may include recognizing the speed of change in the angle of the door based on the recognized amount of change in the angle (ac=a1−a2) and the time T during which the angle of the door changes from a first angle a1 to a second angle a2.

The refrigerator may recognize whether the speed of change in the angle is greater than or equal to a reference speed of change (324).

The refrigerator may generate a closing trigger signal based on the speed of change in the angle being greater than or equal to the reference speed of change (325).

The refrigerator may control the door to be closed based on the generated closing trigger signal (326).

The refrigerator may control the output interface to output a guidance sound for guiding automatic closing of the door based on the generated closing trigger signal.

Controlling the output interface may include controlling the speaker to output the guidance sound.

The refrigerator may also maintain the open state of the door based on the speed of change in the angle being less than the reference speed of change.

The refrigerator may recognize a time of change during which the angle of the door changes based on the speed of change in the angle being less than the reference speed of change (327).

The refrigerator may maintain the open state of the door based on the recognized time of change being less than a reference time (328).

The refrigerator may generate a closing trigger signal based on the recognized time of change being greater than or equal to the reference time (325).

The refrigerator may control the door to be closed based on the generated closing trigger signal (326).

Controlling the door to be closed may include rotating the motor 103 in the second rotation direction. The second rotation direction may be opposite to the first rotation direction for opening the door.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although the embodiments of the disclosure have been provided for illustrative purposes, the scope of the disclosure is limited to the embodiments of the disclosure. One or more embodiments that may be modified and altered by those skilled in the art without departing from the principles and spirit of the disclosure, the scope of which is defined in the claims, should be construed as falling within the scope of the disclosure.

1. A refrigerator, comprising:
a main body having a storage compartment;
a door configured to move in a first direction to open the storage compartment, and move in a second direction to close the storage compartment;
a door moving device including
a motor to generate power,
a door pusher configured to apply a repulsive force to the door to open the door using the power generated by the motor, and
a door link configured to apply an attractive force to the door to close the door using the power generated by the motor;
an angle sensor configured to detect angles of the door that indicate positions of the door, and output angle information about the detected angles; and
a controller configured to:
recognize a state of the door based on the angle information,
in response to the state of the door being recognized as moving in the second direction, recognize angle change information of the door based on the angle information,
generate a closing trigger signal based on the recognized angle change information of the door, and
control the door moving device based on the generated closing trigger signal so that the door link applies the attractive force to the door to close the door using the power generated by the motor.

2. The refrigerator of claim 1, wherein the controller is configured to recognize an amount of change between the detected angles based on the recognized angle change information of the door, and generate the closing trigger signal based on the amount of change between the detected angles being greater than or equal to a reference amount of change.

3. The refrigerator of claim 1, wherein the controller is configured to recognize a speed of change between the detected angles based on the recognized angle change information of the door, and generate the closing trigger signal based on the speed of change between the detected angles being greater than or equal to a reference speed of change.

4. The refrigerator of claim 1, wherein the controller is configured to recognize a time of change between detection of the detected angles based on the recognized angle change information of the door, and generate the closing trigger signal based on the recognized time of change being greater than or equal to a reference time.

5. The refrigerator of claim 1, wherein the controller is configured to recognize an angle of the door from the detected angles of the door based on the recognized angle information, and generate the closing trigger signal based on the recognized angle of the door being less than or equal to a preset angle.

6. The refrigerator of claim 1, wherein the controller is configured to measure an opening time during which the door is open, and generate the closing trigger signal based on the measured opening time being greater than or equal to a preset time.

7. The refrigerator of claim 1, further comprising:
an opening and closing sensor configured to detect an open state and a closed state of the door,
wherein the controller is configured to recognize the state of the door based on detection of the open state or the closed state by the opening and closing sensor.

8. The refrigerator of claim 1, further comprising:
an input interface configured to receive an open door command,
wherein the door moving device includes a link gear connected to the door link,
the controller is configured to control the door moving device based on the open door command being received via the input interface so that the door pusher applies the repulsive force to the door to open the door using the power generated by the motor, and
control the door moving device to allow the link gear to move based on the closing trigger signal being generated.

9. The refrigerator of claim 1, wherein the door moving device includes a first gear assembly connected to the motor and configured to transmit the power generated by the motor as a moving force to the door pusher so that the door pusher applies the repulsive force to the door to open the door, and a second gear assembly connected to the motor and configured to transmit the power generated by the motor as a moving force to the door link so that the door link applies the attractive force to the door to close the door.

10. The refrigerator of claim 9, wherein the first gear assembly includes a clutch gear configured to connect the motor and the door pusher to transmit the power generated by the motor to the door pusher so that the door pusher applies the repulsive force to the door to open the door, and connect the motor and the door link to transmit the power generated by the motor to the door link so that the door link applies the attractive force to the door to close the door.

11. The refrigerator of claim 9, wherein the second gear assembly includes a link gear connected to the door link,
the link gear is configured to be rotated by the door link as the door is opened, and to move the door link using the power generated by the motor so that the door link applies the attractive force to the door to close the door, and
the angle sensor includes a magnet in the link gear configured to rotate in conjunction with the link gear, and a signal generator configured to generate a signal corresponding to a magnetic field of the magnet and transmit the generated signal to the controller.

12. A method for controlling a refrigerator that includes a main body having a storage compartment, a door configured to move in a first direction to open the storage compartment and move in a second direction to close the storage compartment, a door moving device that includes a motor to generate power, a door pusher configured to apply a repulsive force to the door to open the door using the power generated by the motor, and a door link configured to apply an attractive force to the door to close the door using the power generated by the motor, and an angle sensor configured to detect angles of the door that indicate positions of the door and output angle information about the detected angles, comprising:
recognizing a state of a door based on the angle information;
in response to the state of the door being recognized as moving in the second direction, recognizing angle change information of the door based on the angle information;
generating a closing trigger signal based on the recognized angle change information of the door; and
controlling the door moving device based on the generated closing trigger signal so that the door link applies the attractive force to the door to close the door using the power generated by the motor.

13. The method of claim 12, wherein the generating of the closing trigger signal based on the recognized angle change information of the door includes:
recognizing at least one of an amount of change between the detected angles, a speed of change between the detected angles, or a time of change between detection of the angles based on the recognized angle change information of the door, and
generating the closing trigger signal based on the at least one of the amount of change between the detected angles, the speed of change between the detected angles, or the time of change between detection of the detected angles.

14. The method of claim 12, wherein the generating of the closing trigger signal further comprises:
recognizing an angle of the door from the detected angles of the door based on the recognized angle information, and generating the closing trigger signal based on the recognized angle of the door being less than or equal to a preset angle; or
measuring an opening time during which the door is open, and generating the closing trigger signal based on the measured opening time being greater than or equal to a preset time.

15. The method of claim 12, further comprising;
controlling the door moving device so that the door pusher applies a repulsive force to the door to open the door using power generated by the motor, based on an open door command being received via an input interface,
wherein the controlling of the door moving device includes controlling the motor to rotate in a first rotation direction based on the open door command being received, and controlling the motor to rotate in a second rotation direction based on the generated closing trigger signal.
